(19) United States
(12) Patent Application Publication
(10) Pub. No.: US 2025/0340260 A1
(43) Pub. Date: Nov. 6, 2025

(54) IMPROVED CROSSING DEVICE FOR ELECTRIC WHEELCHAIRS

(71) Applicant: NEW LIVE INGENIERE, Betschdorf (FR)

(72) Inventor: Michel OHRUH, Betschdorf (FR)

(21) Appl. No.: 18/723,463

(22) PCT Filed: Dec. 19, 2022
(86) PCT No.: PCT/EP22/86756

§ 371 Date: Nov. 10, 2024

(30) Foreign Application Priority Data
Dec. 29, 2021 (FR) 2114602
Jul. 15, 2022 (FR) 2207286

(51) Int. Cl. B62D 61/12; A61G 5/04; A61G 5/06; B62D 61/10

(52) U.S. Cl. CPC B62D 61/125; B62D 61/10; A61G 5/04; A61G 5/06

(57) ABSTRACT

The obstacle-crossing device for a motorized vehicle having a chassis connected to three wheels on each lateral side of the chassis and a motor to rotate the wheels. There is a mechanism having two arms articulated in pairs about a common pivot axis. The device includes an arm articulated to the chassis on a longitudinal member via a pivot connection. The end of the arm that extends beyond the pivot connection and opposite the motor cooperates with a slide movable on the longitudinal member. A front wheel has a first position in alignment with the other two wheels and a second position which is lowered with respect to the alignment of the other two wheels. The longitudinal member has a fixed wall, and at least one spring. The arm is dimensioned to push back the slide while constraining the spring when the front wheel is in its first position.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to an obstacle-crossing device for motorized vehicles.

### 2. Description of Related Art Including Information Disclosed Under 37 CFR 1.97 and 37 CFR 1.98

The term “motorized vehicle” refers to any machine designed for autonomous movement, such as a robot, wheelchair, etc.

By way of example, which will form the main thread of the present description, the motorized vehicle will relate more particularly to a wheelchair.

This obstacle-crossing device is designed to meet the needs of people with reduced mobility (disabled or elderly) who use wheelchairs on a daily basis, both indoors and outdoors.

In today's society, taking account of people with disabilities is a priority in urban planning projects, in the adaptability of housing, and in access to roads and public or private transport.

Good accessibility is a prerequisite for social, educational, and professional inclusion. Mobility and travel are the key to quality of life, both on a daily basis and in the long term.

For freedom of movement to be genuine, the entire movement system must meet people's specific needs.

The first element in this movement system is undoubtedly the wheelchair, which provides a technical aid to mobility by enabling a person to be transported effortlessly on a flat surface.

Urban planning projects take a long time to implement, on the order of a few years, so wheelchairs have to adapt to the current state of towns, roads and housing.

Roads have many curbs, shops often have a step, homes sometimes have a difference in level from one room to another, and so on. A wheelchair must be able to negotiate these obstacles.

Numerous solutions have been proposed for this purpose. These include wheelchairs with six-wheel technology, which already exist on the market. They offer good maneuverability and stability, but obstacle-crossing is limited to low heights (less than 7.5 cm), and then only with an optional curb-climber which uses leverage to raise the front wheels.

Other 4×4 wheelchairs are available, making it possible to ride over all types of terrain (grass, gravel, pebbles) and over obstacles up to 15 cm high. The main disadvantage of these wheelchairs is their imposing size, which prevents them from being used indoors, and their lack of stability, as there is a risk of tipping forwards or backwards when crossing obstacles.

In particular, an obstacle-crossing device for motorized vehicles is known from the international application published under number WO 2011/095753:
a chassis connected to three wheels on each side;
motor means for rotating the wheels;
and, on each side of the chassis, there is a mechanism comprising two arms, hingedly connected two-by-two about a common pivot axis, on which the three wheels are distributed, respectively a front wheel, an intermediate wheel and a rear wheel, said mechanism allowing each wheel to pivot relative to the axis of each adjacent wheel.

A special feature of this device is that the chassis is connected to each articulated-arm mechanism via two freely rotating shafts, at least one of the shafts being able to compensate for the variation in distance between these two shafts when the arms are not aligned.

In other words, this device has the following unique feature: The distance between two adjacent wheels is always fixed to avoid any padding between them. The wheels can move in height independently of each other when they encounter an obstacle. Specifically, when the chair is facing a curb, the two front wheels will cross first, while the other two wheels will remain in contact with the ground. Then the next two wheels will come in front of the curb and cross it, the other wheels remaining in contact with the ground. Finally, the two rear wheels cross the curb, while the front wheels remain on the ground. At all times, the wheelchair has more than three support points, so as to define a plane that gives the wheelchair stability.

As already mentioned, in the device described in this document WO 2011/095753, the chassis is connected to each articulated arm mechanism via two freely rotating shafts, at least one of which is able to compensate for the variation in distance between these two shafts when the arms are not aligned in a horizontal plane. In fact, when passing over an obstacle, the wheels are not aligned, and the articulated arms pivot accordingly, forming an angle and bringing the two shafts closer together. The wheelchair chassis has fixed dimensions and is connected to these two shafts. To avoid deforming or even breaking the chassis, it is essential to be able to compensate for changes in the center-to-center distance between the articulated arm mounting shafts and the center-to-center distance between these shafts and the chassis, when crossing obstacles.

Generally speaking, such a device has the advantage of being able to offer people with reduced mobility a compact electric wheelchair to facilitate their daily movements, said wheelchair being in particular capable of overcoming obstacles up to 20 cm in height at all forward angles, without risk of tipping over, thus making driving easier in particular for users who have difficulty grasping small obstacles.

In particular, the wheelchair described in international application WO 2011/095753 can advantageously be fitted with a front and/or rear anti-tilt device comprising, on each lateral side of the machine, means for blocking the pivoting of at least one articulated arm when the chassis tilts forwards or backwards.

In addition, this wheelchair can also be fitted with a device to help the user cross the rear of the vehicle, comprising an anti-tilt caster on each side of the vehicle, positioned at the rear of the vehicle.

Another advantage of this wheelchair is that it can be used in the countryside on grass, gravel and pebbles, as well as in snow and sand.

However, there is still room for improvement in this type of obstacle-crossing aid for motorized vehicles.

In particular, improvements need to be made to avoid bumps and to better adapt to uneven ground. In particular, the aim is to improve contact and support between the wheels, especially the front and rear wheels, and the ground, when crossing an obstacle, such as going up or down a curb.

To overcome these problems, and to force the device to adapt optimally to the unevenness of the ground, it has been imagined to equip the crossing device with a return system that enables the front and rear wheels to be pressed down to ground level, in other words to force the device to pivot so that said front or rear wheel is, in turn, forced to come into contact with the ground.

It should also be noted that such a device also improves the front wheel's driveability in the particular case of climbing an obstacle, and facilitates crossing by the rear of the wheelchair by lifting the rear wheel before it hits the obstacle.

### BRIEF SUMMARY OF THE INVENTION

To this end, the present invention relates more particularly to an obstacle-crossing device for a motorized vehicle consisting of a chassis connected to three wheels on each lateral side of the said chassis and of motor means designed to rotate said wheels and, on each lateral side of the chassis, there is a mechanism comprising two arms, articulated in pairs around a common pivot axis, on which two arms are distributed the three wheels, respectively a front wheel, an intermediate wheel and a rear wheel, said mechanism allowing each wheel to pivot with respect to the axis of each adjacent wheel.

Said obstacle-crossing device according to the invention is particular in that the motor means and the rear wheel are borne by an arm articulated to the chassis on a longitudinal member via a pivot connection, the end of the arm that extends beyond the pivot connection and on the opposite side to where the motor means are secured cooperating with a slide which is movable on the longitudinal member, said pivot connection causing the rear wheel to move between two extreme positions, namely a first position in alignment with the other two wheels or a second position which is lowered with respect to the alignment of the other two wheels, said slide comprising a wall perpendicular to the sliding axis, whereas the longitudinal member comprises a fixed wall perpendicular to the sliding axis, at least one spring means being interposed between said two walls, while the arm is dimensioned so that its free end comes into contact with the wall so as to push back the slide while constraining the spring means against said wall, when said front wheel is in its first position aligned with the other two wheels.

According to particular embodiments of the present crossing device:
the arm is supported on the wall of the slide by a roller at the end of said arm;
two spring means are positioned between the walls of the slide;
the motor means and the rear wheel are borne by the arm via a pivot connection;
the device further comprises, on each lateral side, an anti-tilt caster placed at the rear of the motorized vehicle and secured to the first end of said arm opposite the end coming into contact with the wall of the slide;
the device comprises a mechanical device for limiting the movement of the arm when the seat is raised, consisting of a stop that can be moved under the action of raising the seat;
said chassis being connected to each articulated-arm mechanism via two freely rotating shafts, at least one of the two shafts being able to compensate for the variation in distance between these two shafts when the arms are not aligned.

Further objects and advantages of the present invention will become apparent throughout the following description relating to embodiments which are provided only as indicative and non-limiting examples.

### BRIEF DESCRIPTION OF THE SEVERAL VIEWS OF THE DRAWINGS

The understanding of this description will be facilitated by reference to the attached drawings.

FIG. 1 is a schematic side view of the wheelchair placed flat.

FIG. 2 is a partial schematic view of the wheelchair in section A-A.

FIG. 3, FIG. 4, FIG. 5 and FIG. 6 are schematic cross-sectional views of the improved obstacle-crossing device according to the invention, in different positions, from a position where the wheelchair wheels are flat, in FIG. 3, to an obstacle-crossing position, in FIG. 6, passing through two intermediate positions in FIGS. 4 and 5, in order to illustrate the movement of said device and wheels when crossing an obstacle.

### DETAILED DESCRIPTION OF THE INVENTION

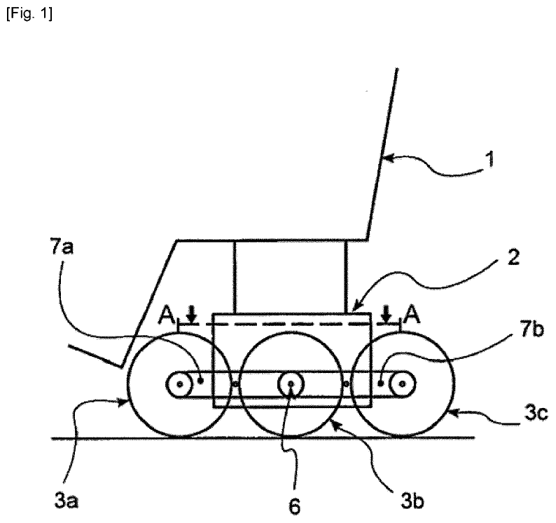

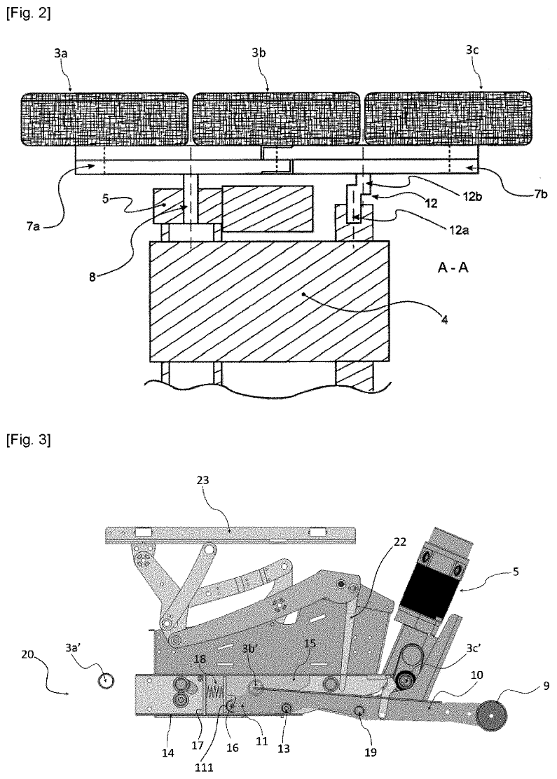

With reference to FIGS. 1 and 2 of the attached drawings, the present invention relates to an obstacle-crossing device for motorized vehicles consisting of:
a chassis 2 on which a wheelchair 1 is fixed, said chassis 2 being connected to three wheels 3a, 3b, 3c on each lateral side; and
motor means 5 for rotating the wheels 3a, 3b, 3c.

On each side of the chassis 2, there is a mechanism comprising two arms 7a, 7b, articulated in pairs around a common pivot axis 6, on which the three wheels 3a, 3b, 3c, respectively, are distributed:
a front wheel 3a, positioned in front of the first articulated arm 7a,
an intermediate wheel 3b, positioned at the joint between the two arms 7a, 7b,
and a rear wheel 3c, positioned behind the second articulated arm 7b.

The two arms 7a, 7b are thus articulated around a common axis corresponding to the axis 6 of the intermediate wheel 3b.

This mechanism, comprising two arms 7a, 7b, allows each wheel to pivot about the axis of each adjacent wheel.

The joint between the two arms 7a, 7b therefore corresponds to a pivot connection.

This allows the front wheel 3a and rear wheel 3c to pivot around the axle 6 of the intermediate wheel 3b. In this way, the three wheels 3a, 3b, 3c can move up and down independently of each other when crossing an obstacle.

According to an advantageous feature of the crossing device of the invention, the chassis 2 of the wheelchair 1 is connected to each articulated arm mechanism 7a, 7b by means of two freely rotating shafts 8, 12, at least one of the shafts being able to compensate for the variation in distance between these two shafts 8, 12 when the arms 7a, 7b are not aligned.

According to a first variant, this condition can be met by a crankshaft made up of two cylindrical sections offset from each other. This offset compensates for the variation in distance between the two shafts when the wheels are not aligned.

In a second variant, the crankshaft may comprise a first shaft section connected to an articulated arm and a second shaft section connected to the chassis, the two shaft sections being articulated to each other by a connecting rod.

According to a third variant, this condition can be fulfilled by a shaft sliding horizontally between two stops defining the maximum and minimum distance allowed between the two shafts. This sliding shaft makes it possible to vary the distance between the two shafts on the articulated arms or on the chassis. For example, this sliding shaft can be inserted into a horizontal slot provided for this purpose in an articulated arm, or into a horizontal slot provided for this purpose on the chassis.

FIG. 2 shows part of the electrical system located under the seat of the wheelchair 1. A battery pack 4 is connected on either side to the front of the articulated-arm mechanism 7a, 7b via a motor 5 and a motor shaft 8, and to the rear of the mechanism via an idler-mounted crankshaft rod 12.

The battery pack 4 is attached to the wheelchair chassis 2. The crankshaft rod 12 is preferably divided into two shafts 12a, 12b whose axes of rotation are slightly offset from one another, in accordance with the first variant described above, the first shaft 12a being integral with the chassis 2, in particular the battery pack 4, while the second shaft 12b is integral with an articulated arm 7b.

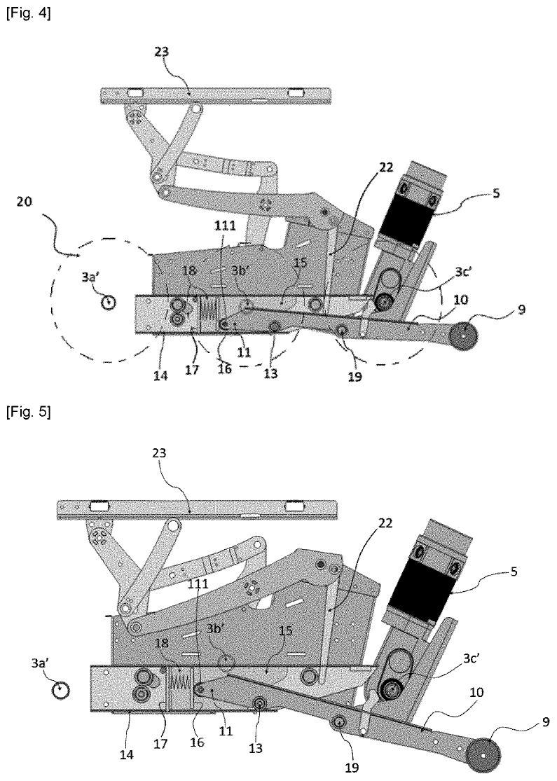

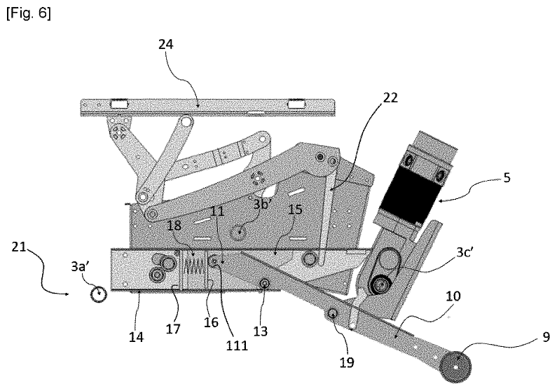

Now, with reference to FIGS. 3 to 6, the obstacle-crossing device for a motorized vehicle of the invention is special in that the motor means 5 and the rear wheel 3c, whose axis, referenced 3c′, is shown on said FIGS. 3 to 6, are borne by an arm 10. Note that the axes 3a′ and 3b′ of the front wheels 3a and intermediate wheels 3b are also shown.

Said arm 10 is articulated to the chassis 2, via a pivot connection 13, on a longitudinal member 14, in the form of a beam.

One of the ends of said arm 10, the end referenced 11 in the figures, which extends beyond said pivot connection 13, and on the opposite side to where the motor means 5 and the rear wheel 3c are secured to said arm 10, cooperates with a slide 15, which is movable on the longitudinal member 14.

In a particularly advantageous way, aid pivot connection 13 of the arm 10 on the longitudinal member 14 makes it possible to cause the front wheel 3a to move between two extreme positions that the latter can take, namely:
a first position 20, shown in the attached FIGS. 3 and 4, wherein said front wheel 3a is in alignment with the other two intermediate wheels 3b and rear wheel 3c; it should be noted here that the three wheels 3a, 3b and 3c are said to be in alignment when said three wheels 3a, 3b and 3c are on a flat surface; and
a second position 21, shown in FIG. 6, wherein said front wheel 3a is no longer in alignment with the other two intermediate wheels 3b and rear wheel 3c, but rather is lowered relative to a plane passing through the axis 3b′ and 3c′ of the intermediate 3b and rear 3c wheels.

Note that FIG. 5 illustrates an intermediate position of the front wheel 3a, when the latter is moving from its first position 20, in which it is in alignment with the other two wheels 3b and 3c, to its second position 21, in which it is lowered relative to the two intermediate wheels 3b and rear wheel 3c.

In addition, said slide 15 has a wall 16, perpendicular to the sliding axis, on which the end 11 of the arm 10 rests.

The longitudinal member 14 has a fixed wall 17 which is also perpendicular to the sliding axis.

At least one spring means 18 is interposed between the wall 16 of the slide 15 and the wall 17 of the longitudinal beam 14.

It should be noted that, preferably, two spring means 18 are positioned between the two walls 16 of the slide 15 and 17 of the longitudinal member 14 to balance the pressure and ensure perfect sliding of the slide 15.

The spring means 18 between the wall 16 of the slide 15 and the wall 17 of the longitudinal member 14 is tensioned when said two walls 16, 17 are brought together, when the front wheel 3a is in its first position 20, in alignment with the other two intermediate 3b and rear 3a wheels.

To this end, the arm 10 is dimensioned so that its end 11 comes into contact with the wall 16 of the slide 15, so as to push back and move same, constraining said at least one spring means 18.

According to an advantageous feature of the crossing device of the invention, the support of the arm 10 on the wall 16 of the slide 15 is provided via a roller 111.

The fact that the end 11 of the arm 10 is fitted with a roller 111, which then rolls on the wall 16 of the slide 15, prevents damage to said wall 16.

Furthermore, advantageously, the motor means 5 and the rear wheel 3c are borne by the arm 10 via a pivot connection 19.

Crossing an obstacle, such as climbing a curb, takes place as follows:
first, the three wheels 3a, 3b and 3c rest on the ground at the foot of the curb and are aligned,
in the next step, the front wheel 3a climbs the curb, the wheels 3a, 3b and 3c remaining aligned with the intermediate wheel 3b “in the air”,
in the next step, under the driving action of the front wheels 3a and rear wheels 3c, the intermediate wheel 3b comes into contact with the curb, thus relieving the load and causing, under the effect of the relaxation of the spring means, the arm 10 to form an angle relative to the longitudinal member 14, around the pivot connection 13, and consequently raising the intermediate wheel 3b, thus preventing it from hitting the curb.

Particularly preferably, the obstacle-crossing device further comprises an anti-tilt caster 9 on each side and at the rear of the wheelchair 1.

Each of the said anti-tilt casters 9 with which the device of the invention is equipped is fixed to the end of the arm 10 which is opposite the end 11 of said arm 10 which comes into contact with the wall 16 of the slide 15.

The anti-tilt casters 9 also provide temporary support when crossing an obstacle such as a curb, from a certain height, until the rear wheel 3c comes into contact with the curb, thus preventing it from hitting the curb edge.

Preferably, the present obstacle-crossing device also features a mechanical device for limiting the movement of the arm 10 when the seat 23 of the wheelchair 1 is raised. This device for limiting the movement of the arm 10 consists of a mobile stop 22 that can be moved under the action of raising the seat 23.

Such an elevation of the seat 24 is shown in particular in FIG. 4, which clearly illustrates that said seat 24 is raised compared to the position it occupies in the other figures.

When the wheelchair is in motion on horizontal or substantially horizontal ground, the weight of the assembly (user, wheelchair, etc.), comes to rest on the intermediate wheel 3b, the three wheels 3a, 3b and 3c are aligned, the end 11 of the arm 10 presses on the wall 16, causing the spring means 18 to compress.

In this configuration, shown in FIGS. 3 and 4 (FIG. 4 illustrating a view in which the seat of the wheelchair 1 has been raised relative to the view in FIG. 3), the arm 10 bearing, at the rear relative to the pivot connection 13, the motor means 5 and the rear wheel 3c and also, preferably, at its rear end, the anti-tilt caster 9, is aligned, or substantially aligned, with the longitudinal member 14.

Still in this configuration, the end 11 of the arm presses against the wall 16 of the slide 15 which, by moving, compresses the spring means 18, or the plurality of spring means 18 as the case may be.

When crossing an obstacle, for example when the user of wheelchair 1 wishes to climb onto or off a curb, the weight of the assembly is no longer sufficient to align the wheels 3a, 3b and 3c.

Referring to FIGS. 5 and 6, the spring 18 then pushes back the wall 16 and the slide 15, causing the arm 10 to pivot via the pivot connection 13, forming an angle between the axes 3a′, 3b′ and 3c′ of the three wheels, front 3a, intermediate 3b and rear 3c, and optimizing the ground contact of the front wheel 3a in particular.

When going down a curb, the thrust of the springs 18 prevents the rear wheel 3c from lifting, thus avoiding the risk of the wheelchair tipping forward.

I claim:

1. An obstacle-crossing device for a motorized vehicle being comprised of a chassis connected to three wheels on each lateral side of said chassis and motor means adapted to rotate said wheels and, on each lateral side of the chassis, the device comprising:
two arms, articulated in pairs around a common pivot axis, on which two arms are distributed the three wheels, respectively a front wheel, an intermediate wheel and a rear wheel, said mechanism enabling each wheel to pivot with respect to the axis of each adjacent wheel; and
an arm bearing the motor means and the rear wheel articulated to the chassis on a longitudinal member via a pivot connection,
wherein an end of the arm extends beyond the pivot connection and on the opposite side to where the motor means are secured cooperating with a slide which is movable on the longitudinal member, the pivot connection causing the front wheel to move between two end positions, a first position being in alignment with the other two wheels, a second position being lowered with respect to the alignment of the other two wheels, the slide having a wall perpendicular to a sliding axis,
wherein the longitudinal member has a fixed wall perpendicular to the sliding axis, at least one spring means being interposed between the two walls, and
wherein the arm is dimensioned such that its free end comes into contact with the wall so as to push back the slide while constraining the spring means against the wall when the front wheel is in its first position aligned with the other two wheels.

2. The obstacle-crossing device for a motorized vehicle, according to claim 1, wherein the arm bears on the wall of the slide via a roller on the end of said arm.

3. The obstacle-crossing device for a motorized vehicle, according to claim 1, wherein two spring means are positioned between the walls of the slide.

4. The obstacle-crossing device for a motorized vehicle, according to claim 1, wherein the motor means and the rear wheel are borne by the arm via a pivot connection.

5. The obstacle-crossing device for a motorized vehicle, according to claim 1, further comprising, on each lateral side, an anti-tilt roller placed at the rear of the motorized vehicle and fixed to the first end of said arm opposite the end coming into contact with the wall of the slide.

6. The obstacle-crossing device for a motorized vehicle, according to claim 5, further comprising a mechanical device for limiting the movement of the arm when the seat is raised, the mechanical device being comprised of a stop that can be moved under the action of raising the seat.

7. The obstacle-crossing device for a motorized vehicle, according to claim 1, wherein said chassis is connected to each articulated arm mechanism by means of by two freely rotating shafts, at least one of the two shafts being able to compensate for the variation in distance between these two shafts when the arms are not aligned.
